(19) United States
(12) Patent Application Publication
(10) Pub. No.: US 2020/0365906 A1
(43) Pub. Date: Nov. 19, 2020

(54) ALUMINUM-ALLOY FOIL FOR CURRENT COLLECTOR AND METHOD FOR MANUFACTURING THEREOF

(71) Applicant: UACJ Corporation, Tokyo (JP)

(72) Inventor: Hiroki TANAKA, Aichi (JP)

(21) Appl. No.: 16/638,920

(22) PCT Filed: Aug. 10, 2018
(86) PCT No.: PCT/JP2018/030071

§ 371 Date: Feb. 13, 2020

(30) Foreign Application Priority Data
Sep. 28, 2017 (JP) 2017-188307

(51) Int. Cl. H01M 4/66; H01M 4/04

(52) U.S. Cl. CPC H01M 4/662; H01M 4/0435

(57) ABSTRACT

Provided are an aluminum-alloy foil for a current collector, which excels in durability with regard to thermal cycling and can damp vibrations from the outside effectively, and a method for manufacturing the aluminum-alloy foil. The aluminum-alloy foil for a current collector has a chemical composition containing Fe: 1.1-1.8 mass %, Si: 0.30 mass % or less, Cu: 0.030 mass % or less, Mg: 0.030 mass % or less, Mn: 0.040 mass % or less, and Ti: 0.050 mass % or less, the remainder being Al and unavoidable impurities; and a cold-worked structure, and exhibits a property that it recrystallizes at a temperature of 150° C. or higher. In addition, when completely recrystallized, the aluminum-alloy foil exhibits the properties of an elongation of 5.6% or more and a logarithmic decrement of damped free oscillations of 1.0×10⁻³ or more.

### TECHNICAL FIELD

The present invention relates to an aluminum-alloy foil for a current collector and to a manufacturing method thereof.

### BACKGROUND ART

Lithium-ion secondary batteries are widely used as batteries mounted on various devices such as automobiles, notebook-sized personal computers, etc. The positive electrode of a lithium-ion secondary battery includes a current collector composed of an aluminum-alloy foil and a positive-electrode active material layer that contains a positive-electrode active material and is disposed on a surface of the current collector.

The positive electrode of a lithium-ion secondary battery is normally manufactured according to the following process. Specifically, after a paste containing a positive-electrode active material and a binder has been applied onto a surface of an aluminum-alloy foil serving as the current collector, the paste is dried to form a positive-electrode active material layer on the surface of the current collector. Then, after the current collector provided with the positive-electrode active material layer has been rolled, the positive electrode can be obtained by cutting into the desired dimensions (for example, Patent Document 1).

In order to curtail breakages, etc. of the aluminum-alloy foil during the above-mentioned manufacturing process of the positive electrode, it is preferable to use an aluminum-alloy foil having a relatively high strength. However, aluminum-alloy foils have the tendency that elongation decreases with increasing strength. Because the positive electrode of a lithium-ion secondary battery repetitively expands and contracts during charging/discharging, there is a risk that the aluminum-alloy foil will deteriorate prematurely due to the repeated expansion and contraction in case an aluminum-alloy foil having small elongation is used as the current collector. Furthermore, in some cases, there is a risk that the aluminum-alloy foil will break prematurely.

Then, as a result of earnest investigations, the present inventors found an aluminum-alloy foil exhibiting the properties of having sufficient strength at the time of application, drying and rolling during electrode manufacturing, and thereafter of starting to soften at a low temperature of around 120° C. (Patent Document 2). With regard to this aluminum-alloy foil, a reduction of strength can be curtailed by ensuring that the temperature of the aluminum-alloy foil does not exceed 120° C. during the manufacturing process of the positive electrode. Consequently, breakage of the aluminum-alloy foil in the manufacturing process of the positive electrode can be curtailed. Furthermore, by performing a heat treatment at a temperature as low as possible, of 200° C. or less, on the positive electrode prior to being assembled in a lithium-ion secondary battery, elongation of the aluminum-alloy foil can be improved, and thus the durability of the aluminum-alloy foil with regard to charging/discharging cycles can be improved accordingly.

### PRIOR ART LITERATURE

### Patent Documents

Patent Document 1

JP-A-2007-234277

Patent Document 2

Japanese Patent No. 5591583

### SUMMARY OF THE INVENTION

### Problems to be Solved by the Invention

In recent years, it has been strongly desired to improve the durability of aluminum-alloy foils with regard to charging/discharging cycles. Therefore, there is a demand to increase the elongation of aluminum-alloy foils after having been subjected to a heat treatment more than that of the aluminum-alloy foil of Patent Document 2.

In addition, with regard to positive electrodes that are equipped with a previously-existing aluminum-alloy foil, there is a risk that the positive-electrode active material layer will be peeled off from the aluminum-alloy foil serving as the current collector in case intense vibration is applied from the outside, e.g., in applications such as automobile batteries, thereby leading to a reduction in battery capacity. In order to avoid such problems, there is a demand for an aluminum-alloy foil that can inhibit peeling of the positive-electrode active material layer when vibrations are applied from the outside.

The present invention has been made considering this background and aims to provide an aluminum-alloy foil for a current collector, which excels in durability with regard to thermal cycling and can effectively damp external vibrations, and a method for manufacturing the aluminum-alloy foil.

### Means for Solving the Problems

One aspect of the present invention is an aluminum-alloy foil for a current collector, having:

a chemical composition composed of Fe (iron): 1.1-1.8 mass %, Si (silicon): 0.30 mass % or less, Cu (copper): 0.030 mass % or less, Mg (magnesium): 0.030 mass % or less, Mn (manganese): 0.040 mass % or less, and Ti (titanium): 0.050 mass % or less, the remainder being Al (aluminum) and unavoidable impurities; and

a cold-worked structure,

wherein the aluminum-alloy foil exhibits the properties of:

recrystallizing at a temperature of 150° C. or higher, and

when completely recrystallized, an elongation of 5.6% or more and a logarithmic decrement of damped free oscillations of 1.0×10⁻³ or more.

Another aspect of the present invention is a method of manufacturing the aluminum-alloy foil for a current collector of the above-mentioned aspect, including:

preparing an ingot having said chemical composition;

performing a homogenizing treatment by holding the ingot at a temperature of 400-580° C.;

preparing a hot-rolled sheet by performing hot-rolling on the ingot under the condition that the coiling temperature is the recrystallization temperature or less;

preparing a cold-rolled sheet by performing cold-rolling on the hot-rolled sheet;

performing an intermediate annealing by holding the cold-rolled sheet at a temperature of 300-340° C.; and

performing foil rolling on the cold-rolled sheet under the condition that the rolling ratio is set to 85% or more, and the coiling temperature is less than 90° C.

### Effects of the Invention

The above-mentioned aluminum-alloy foil for a current collector (hereinafter referred to as “aluminum-alloy foil” as appropriate) has the chemical composition specified above and the cold-worked structure. Accordingly, the property of recrystallizing at a temperature of 150° C. or higher can be achieved. Furthermore, an aluminum-alloy foil having such a property can maintain high strength during the manufacturing process of a positive electrode, and breakage of the aluminum-alloy foil can be curtailed.

Moreover, with regard to the aluminum-alloy foil, by setting the Mg content to 0.030 mass % or less, the elongation when completely recrystallized can be made greater than aluminum-alloy foils that were prepared with previously-existing composition ranges. Accordingly, with regard to this aluminum-alloy foil, deterioration in cases in which expansion and contraction are repeated can be curtailed, and durability with regard to charging/discharging cycles can be increased, as compared with previously-existing aluminum-alloy foils.

Furthermore, in the aluminum-alloy foil that has been completely recrystallized, the logarithmic decrement of damped free oscillations is 1.0×10⁻³ or more. By setting the logarithmic decrement to the above-specified range, the aluminum-alloy foil can effectively damp vibrations applied from the outside. Therefore, by using the aluminum-alloy foil as a current collector for a positive electrode, vibrations of the current collector in cases in which vibrations are applied from the outside can be curtailed, and peeling of the positive electrode active material layer can be curtailed.

As mentioned above, the aluminum-alloy foil excels in durability with regard to charging/discharging cycles, and can effectively damp vibrations from the outside.

### BRIEF DESCRIPTION OF THE DRAWINGS

FIG. 1 is a side view that shows a main part of a logarithmic decrement measurement device according to a working example.

FIG. 2 is an explanatory diagram that shows one example of a waveform of damped free oscillations according to the working example.

### MODES FOR CARRYING OUT THE INVENTION

Reasons for specifying the chemical composition, etc. of the aluminum-alloy foil are described below.

Fe (Iron): 1.1-1.8 Mass %

Fe is present in a solid solution in the aluminum-alloy foil in an oversaturated state. In case the aluminum-alloy foil is heated to a temperature of around 100° C., a portion of the Fe, which had dissolved in the Al matrix, precipitates as fine Al-Fe-based compounds having a particle diameter of less than 5 nm. Due to the fact that the fine Al-Fe-based compounds impede the migration of dislocations, the aluminum-alloy foil can be inhibited from softening in a temperature range of 120° C. or less, and can maintain high strength.

On the other hand, because the diffusion speed of Fe in a solid solution is comparatively slow in the temperature range of 120-200° C., the recovery speed of the cold-worked structure is faster than the precipitation of the Al-Fe-based compounds. Therefore, the aluminum-alloy foil has the property that, when subjected to a heat treatment, recovery of the cold-worked structure starts at a temperature of around 120° C. and the tensile strength decreases. By further continuing the heat treatment of the aluminum-alloy foil so that the temperature reaches 150° C. or higher, the aluminum-alloy foil can be recrystallized. Consequently, elongation of the aluminum-alloy foil can be increased as compared with before the heat treatment.

In addition, when the aluminum-alloy foil is heated to a temperature of 120° C. or higher, a portion of the Fe does not precipitate as Al-Fe-based compounds, and instead is dissolved in the Al matrix. Vibrations applied from the outside can be effectively damped by this solid-solution Fe.

As mentioned above, Fe is an important element to achieve the properties that the aluminum-alloy foil maintains its strength in a heat treatment at a temperature of around 100° C., and softens with a greater elongation upon being subjected to a heat treatment at a temperature of 150° C. or higher, as compared with before the heat treatment. By setting the Fe content to the above-specified range, such properties are achieved, and simultaneously the elongation and logarithmic decrement of the completely recrystallized aluminum-alloy foil can be set to the above-specified ranges.

If the Fe content is less than 1.1 mass %, the logarithmic decrement of the completely recrystallized aluminum-alloy foil will be less than the above-specified range because the amount of solid-solution Fe in the Al matrix becomes small. Thus, it becomes difficult to damp vibrations applied from the outside. From the viewpoint of further increasing the logarithmic decrement of the completely recrystallized aluminum-alloy foil to thereby damp vibrations applied from the outside more effectively, the Fe content is preferably set to 1.2 mass % or more.

If the Fe content exceeds 1.8 mass %, coarse Al-Fe-based compounds having particle sizes exceeding several hundred micrometers precipitate during preparation of an ingot in the manufacturing process of the aluminum-alloy foil. If the aluminum-alloy foil is manufactured in the state that such coarse Al-Fe-based compounds are included, pinholes tend to be formed in the aluminum-alloy foil during foil rolling. Therefore, if the Fe content exceeds 1.8 mass %, it is difficult to manufacture a robust aluminum-alloy foil. From the viewpoint of inhibiting precipitation of coarse Al-Fe-based compounds and more reliably avoiding the formation of pinholes, the Fe content is preferably set to 1.6 mass % or less.

As mentioned above, a portion of the Fe in the aluminum-alloy foil is dissolved in an Al matrix, and the rest is dispersed in the Al matrix as Al-Fe-based compounds. In the Al matrix, Al-Fe-based compounds having a circle-equivalent diameter of 10 to 50 nm are preferably dispersed at 800 particles/μm³ or more. With regard to Al-Fe-based compounds having a circle-equivalent diameter in the above-specified range, matching with the Al matrix is low. For this reason, by dispersing the Al-Fe-based compounds in the Al matrix at 800 particles/μm³ or more, recovery and recrystallization of the cold-worked structure can be promoted when a heat treatment is performed at a temperature of 150° C. or higher. Consequently, the aluminum-alloy foil can be recrystallized at a lower temperature, and the elongation of the completely recrystallized aluminum-alloy foil can be further increased.

The amount of solid-solution Fe in the Al matrix is preferably 0.015-0.035 mass %. In this case, numerous fine Al-Fe-based compounds can be precipitated in the Al matrix when a heat treatment is performed on the aluminum-alloy foil at a temperature of around 100° C. Consequently, a reduction of strength can be effectively inhibited when a heat treatment is performed at a temperature of around 100° C.

Furthermore, when completely recrystallized, the aluminum-alloy foil preferably has the property that the amount of Fe dissolved in the Al matrix falls within 0.010 to 0.030 mass %. As mentioned above, Fe dissolved in an Al matrix can effectively damp vibrations applied from the outside. Therefore, in this case, the logarithmic decrement of the completely recrystallized aluminum-alloy foil can be further increased to thereby damp vibrations applied from the outside more effectively.

Si (Silicon): 0.30 Mass % or Less

Although Si is not an essential element, it may be mixed in the aluminum-alloy foil in some cases. If the Si content becomes too high, second phase particles such as elemental silicon, Al-Fe-Si-based compounds, etc. tend to precipitate in the Al matrix, and thus there is a risk that a reduction of ductility of the aluminum-alloy foil may be caused. In order to avoid such a reduction of the ductility of the aluminum-alloy foil, the Si content is set to 0.30 mass % or less. From the same viewpoint, the Si content is preferably set to 0.10 mass % or less. It is noted that the above-described concept of “Si: 0.30 mass % or less” is a concept that includes a case in which the Si content is 0 mass %.

Ti (Titanium): 0.50 Mass % or Less

The aluminum-alloy foil may contain Ti as an optional element. Ti has a function of making the cast structure fine. However, if the Ti content is excessively high, pinholes tend to form in the aluminum-alloy foil during foil rolling. By setting the Ti content within the above-specified range, the formation of pinholes during foil rolling can be avoided, and simultaneously variations in the mechanical properties of the aluminum-alloy foil can be further reduced. It is noted that the above-described concept of “Ti: 0.050 mass % or less” is a concept includes a case in which the Ti content is 0 mass %.

B (Boron): 0.010 Mass % or Less

The aluminum-alloy foil may contain B as an optional element. B in coexistence with Ti can make the cast structure fine, like Ti. However, if the B content is excessively large, pinholes tend to form in the aluminum-alloy foil during foil rolling. By setting the B content within the above-specified range, the formation of pinholes during foil rolling can be avoided, and simultaneously variations in the mechanical properties of the aluminum-alloy foil can be further reduced. It is noted that the above-described concept of “B: 0.010 mass % or less” is a concept that includes a case in which the B content is 0 mass %.

Mn (Manganese): 0.040 Mass % or Less

The aluminum-alloy foil may contain Mn as an optional element. Mn has a function of increasing the strength of the aluminum-alloy foil. However, if the Mn content is excessively large, there is a risk that the elongation of the completely recrystallized aluminum-alloy foil may decrease. By setting the Mn content within the above-specified range, a decrease of the elongation can be avoided, and simultaneously the strength of the aluminum-alloy foil can be further increased. It is noted that the above-described concept of “Mn: 0.040 mass % or less” is a concept that includes a case in which the Mn content is 0 mass %.

Cu (Copper): 0.030 Mass % or Less

The aluminum-alloy foil may contain Cu as an optional element. Cu dissolves in the Al matrix, and has a function of increasing the strength of the aluminum-alloy foil. However, if the Cu content is excessively large, there is a risk that elongation of the completely recrystallized aluminum-alloy foil may decrease because the solid solution amount of Cu increases. By setting the Cu content within the above-specified range, a decrease of the elongation can be avoided, and simultaneously the strength of the aluminum-alloy foil can be further increased. It is noted that the above-described concept of “Cu: 0.030 mass % or less” is a concept that includes a case in which the Cu content is 0 mass %.

Mg (Magnesium): 0.030 Mass % or Less

The aluminum-alloy foil may contain Mg as an optional element. Mg dissolves in the Al matrix, and has a function of increasing the strength of the aluminum-alloy foil. However, if the Mg content is excessively large, there is a risk that elongation of the completely recrystallized aluminum-alloy foil may decrease because the solid solution amount of Mg increases. By setting the Mg content within the above-specified range, a decrease of the elongation can be avoided, and simultaneously the strength of the aluminum-alloy foil can be further increased. It is noted that the above-described concept of “Mg: 0.030 mass % or less” is a concept that includes a case in which the Mg content is 0 mass %.

Other Elements

Elements such as Zn (zinc), Ga (gallium), Ni (nickel), Cr (chromium), Sn (tin), Pb (lead), V (vanadium) may be contained in the aluminum-alloy foil as impurities. If the contents of these elements are excessively large, there is a risk that an increase of the start temperature of recrystallization may be caused. By setting the contents of these elements to 0.020 mass % or less, an increase of the start temperature of recrystallization can be avoided. It is noted that the contents of these elements may be 0 mass %.

Metallographic Structure and Mechanical Properties Before Recrystallization

The aluminum-alloy foil has a cold-worked structure. Accordingly, as mentioned above, high strength can be maintained during the manufacturing process of the positive electrode and breakage of the aluminum-alloy foil can be curtailed.

In addition, the aluminum-alloy foil preferably has a tensile strength of 160 MPa or more. In this case, breakage of the aluminum-alloy foil during the manufacturing process of the positive electrode can be curtailed more effectively.

Furthermore, from the viewpoint of more effectively curtailing the breakage of the aluminum-alloy foil during the manufacturing process of the positive electrode, it is preferable to curtail softening of the aluminum-alloy foil after having been heated to a temperature of less than 120° C. From such a viewpoint, the tensile strength after having been immersed in an oil bath of 100° C. for 1 minute is preferably 150 MPa or more.

Recrystallization Temperature: 150° C. or Higher

The aluminum-alloy foil has a property that it recrystallizes at a temperature of 150° C. or higher. In common manufacturing processes of a positive electrode, the aluminum-alloy foil serving as the current collector is heated to around 100° C., for example, when drying a positive-electrode active material layer, etc. Because the start temperature of recrystallization of the aluminum-alloy foil is 150° C. or higher, softening of the aluminum-alloy foil and an increase in ductility of the aluminum-alloy foil can be easily avoided in the manufacturing process of the positive electrode. Accordingly, high strength can be maintained during the manufacturing process of the positive electrode and breakage of the aluminum-alloy foil can be curtailed.

In addition, the start temperature of recrystallization of the aluminum-alloy foil is preferably 200° C. or less. Lithium cobalt oxide, lithium-nickel complex compounds, etc. are used as a positive-electrode active material for a lithium-ion secondary battery. With regard to these positive-electrode active materials, there is a risk of deterioration in the case they are heated to a temperature higher than 200° C., and in some cases, there is a risk that electrical properties may be impaired. Therefore, by setting the start temperature of recrystallization of the aluminum-alloy foil to 200° C. or less, deterioration of the positive-electrode active material due to heating can be avoided, and the elongation of the completely recrystallized aluminum-alloy foil can be increased.

Mechanical Properties After Recrystallization

The completely recrystallized aluminum-alloy foil has an elongation of 5.6% or more. In addition, in the completely recrystallized aluminum-alloy foil, the logarithmic decrement of damped free oscillations is 1.0×10⁻³ or more. These post-recrystallization properties can be achieved at least by having the above-specified chemical composition.

Furthermore, tensile strength after having been immersed in an oil bath of 120° C. for 1 minute is preferably less than 150 MPa. By specifying the softening property of the aluminum-alloy foil at 120° C. as mentioned above, the ductility of the aluminum-alloy foil, which has been subjected to a heat treatment at a temperature of 150° C. or higher, can be further increased. Thus, the durability of the aluminum-alloy foil with regard to charging/discharging cycles can be further increased.

Manufacturing Method

The aluminum-alloy foil can be manufactured, for example, according to the following process. First, an ingot having the above-specified chemical composition is prepared. The ingot may be prepared, for example, by a method such as continuous-casting, DC casting, etc.

Next, a homogenizing treatment is performed by holding the ingot at a temperature of 400-580° C. If the holding temperature during the homogenizing treatment is less than 400° C., there is a risk that homogenization of the ingot structure will be insufficient, so that variations in the mechanical properties of the resulting aluminum-alloy foil may increase. Moreover, if the holding temperature exceeds 580° C., the sizes of the Al-Fe compounds that are present in the ingot increase due to so-called Ostwald ripening, and simultaneously the number thereof decreases. As a result, there is a risk that an increase of the recrystallization start temperature may be caused, and it may become difficult to increase the elongation of the aluminum-alloy foil by a heat treatment at a temperature of 150° C. or higher.

Although the holding time in the homogenizing treatment is not particularly limited, an increase of manufacturing cost will be caused if the holding time is excessively increased. From the viewpoint of avoiding an increase of the manufacturing cost, the holding time is preferably set to 24 hours or less.

After performing the homogenizing treatment, hot-rolling is performed on the ingot, under the condition that the coiling temperature is the recrystallization temperature or less, to prepare a hot-rolled sheet. By setting the coiling temperature of the hot-rolled sheet to the recrystallization temperature or less, precipitation of Fe in the hot-rolled sheet can be curtailed. As a result, the solid solution amount of Fe in the aluminum-alloy foil can be sufficiently rich. In addition, in this case, dislocations can be introduced into the hot-rolled sheet. The dislocations introduced into the hot-rolled sheet form precipitation sites for Al-Fe-based compounds during an intermediate annealing that will be performed later. Therefore, by introducing dislocations into the heat-rolled sheet, precipitation of the Al-Fe-based compounds during the intermediate annealing can be promoted.

It is noted that the above-mentioned “recrystallization temperature” means a temperature at which the hot-rolled sheet is completely recrystallized when it has been held for one hour at the aforesaid temperature. The recrystallization temperature of the hot-rolled sheet is higher than the temperature at which recrystallization of the aluminum-alloy foil starts.

From the viewpoint of further increasing effects of inhibiting Fe precipitation and introducing dislocations, it is more preferable to perform hot-rolling under the condition that the coiling temperature of the hot-rolled sheet is 260° C. or less.

After performing the hot-rolling, an intermediate annealing may be performed on the resulting hot-rolled sheet as needed. The intermediate annealing after hot-rolling may be performed, for example, under the condition that it is held for 1-10 hours at a temperature of 320-400° C. By performing the intermediate annealing, variations in the mechanical properties can be reduced, and the occurrence of breaks at the end portion of the cold-rolled sheet in the sheet width direction can be curtailed more effectively during cold-rolling.

Next, the cold-rolled sheet is prepared by performing cold-rolling on the hot-rolled sheet. The conditions of the cold-rolling are not particularly limited. The sheet thickness of the cold-rolled sheet can be set appropriately within the range of 0.2-1.5 mm.

After performing the cold-rolling, an intermediate annealing is performed by holding the resulting cold-rolled sheet at a temperature of 300-340° C. Accordingly, variations in the mechanical properties of the resulting aluminum-alloy foil can be reduced. If the holding temperature during this intermediate annealing is less than 300° C., there is a risk that the effect of reducing the variations in mechanical properties may be decreased. Moreover, if the holding temperature exceeds 340° C., coarse recrystallized particles tend to form after the intermediate annealing. As a result, there is a risk that pinholes may tend to be formed during the foil rolling.

The holding time in the intermediate annealing after cold-rolling is preferably set to 2 hours or more from the viewpoint of reducing variations in the mechanical properties. Furthermore, from the viewpoint of avoiding an increase in manufacturing cost, the holding time is preferably set to 12 hours or less, and more preferably set to 8 hours or less.

The aluminum-alloy foil can be obtained by performing foil rolling on the cold-rolled sheet after performing the intermediate annealing. The number of passes in the foil rolling may be one, or two or more. The rolling ratio in the foil rolling, i.e., the reduction ratio of sheet thickness, in case the sheet thickness of a cold-rolled sheet is taken as 100%, is set to 85% or more. Thereby, the metallographic structure of the aluminum-alloy foil can be formed as a desired cold-worked structure, and properties can be imparted such that strength is maintained when a heat treatment is performed at around 100° C., and elongation increases when a heat treatment is performed at a temperature of 150° C. or higher.

The rolling ratio in the foil rolling is preferably set to 95% or more. In this case, a larger amount of distortion energy can be stored in the cold-worked structure of the aluminum-alloy foil. Then, due to the fact that this distortion energy serves as a driving force for recrystallization, the aluminum-alloy foil can be recrystallized at a lower temperature.

If the rolling ratio in the foil rolling is less than 85%, the distortion energy, which has been stored in the cold-worked structure after the foil rolling, will be insufficient. Therefore, if a heat treatment is performed at a temperature of 150° C. or higher, there is a risk that recrystallization of the aluminum-alloy foil will not be completed, and thus a reduction of ductility may be caused.

In addition, the coiling temperature of the aluminum-alloy foil in each pass of the foil rolling is set to less than 90° C. Thereby, a sufficiently large amount of distortion energy can be stored in the cold-worked structure after the foil rolling. Consequently, when a heat treatment is performed at a temperature of 150° C. or higher, the property of increased elongation can be imparted to the aluminum-alloy foil.

If the coiling temperature of the aluminum-alloy foil exceeds 90° C. in any pass in the foil rolling, there is a risk that the cold-worked structure will be recovered in the coiled aluminum-alloy foil and the distortion energy that has been stored in the cold-worked structure after the foil rolling will be insufficient. Therefore, there is a risk that recrystallization of the aluminum-alloy foil will not be completed when the heat treatment has been performed at a temperature of 150° C. or higher, and a reduction of ductility will be caused.

### Working Examples

Working examples of the aluminum-alloy foil and a manufacturing method thereof are explained below. It is noted that modes of the aluminum-alloy foil and the manufacturing method thereof according to the present invention are not limited to the modes of the working examples, and the compositions can be modified as appropriate within a range that does not depart from the gist thereof.

In the present example, aluminum-alloy foils having a thickness of 15 μm were first manufactured according to the following process, and using the resulting aluminum-alloy foils, the number of Al-Fe-based compounds that were dispersed in an Al matrix, the specific resistance, the mechanical properties, and the presence/absence of pinholes were assessed. In addition, separately from these, strip test pieces having a thickness of 0.6 mm were manufactured, and using the resulting strip test pieces, the logarithmic decrement of damped free oscillations was measured. Details are as follows.

Number of Al-Fe-Based Compounds

First, aluminum-alloy ingots having the chemical compositions shown in Table 1 (alloy symbols A-L) were manufactured by DC casting. The resulting ingots were held at a temperature of 520° C. for 10 hours to perform a homogenizing treatment. After the homogenizing treatment, hot-rolling was performed on the ingots under the condition that the coiling temperature was 230° C. to obtain hot-rolled sheets having a sheet thickness of 3 mm. It is noted that the symbol “Bal.” in Table 1 shows the remainder (balance).

Cold-rolling was performed on the hot-rolled sheets and cold-rolled sheets having a sheet thickness of 0.5 mm were obtained. After performing an intermediate annealing by holding the cold-rolled sheets at a temperature of 310° C. for 6 hours, foil rolling was performed on the cold-rolled sheets and aluminum-alloy foils having a thickness of 15 μm were obtained. The number of passes in the foil rolling was set to a plurality of passes, the coiling temperature of the aluminum-alloy foils after each pass has been completed was set to 60-80° C. The rolling reduction in the foil rolling was 97%.

Mechanical Properties

Using the above-mentioned aluminum-alloy foils, tension tests were performed and initial tensile strengths were measured. In order to simulate a current collector in a manufacturing process of a positive electrode, the aluminum-alloy foils were subjected to a heat treatment by immersing them in an oil bath of 100° C. for 1 minute. Tension tests were performed on the aluminum-alloy foils after the heat treatment, and tensile strengths in the manufacturing process of the positive electrode were measured.

Further, after manufacturing the positive electrodes, in order to simulate a current collector after having been subjected to a heat treatment at a temperature of 120° C., the aluminum-alloy foils were subjected to a heat treatment by immersing them in an oil bath of 120° C. for 1 minute. Tension tests were performed on the aluminum-alloy foils after the heat treatment, and tensile strengths after having been subjected to the heat treatment at a temperature of 120° C. were measured.

Furthermore, after manufacturing the positive electrodes, in order to simulate a current collector after having been subjected to a heat treatment at a temperature of 170° C., the aluminum-alloy foils were subjected to a heat treatment by immersing them in an oil bath of 170° C. for 1 minute. Tension tests were performed on the aluminum-alloy foils after the heat treatment, and tensile strength and elongation after having been subjected to the heat treatment at a temperature of 170° C. were measured. The results thereof were as shown in Table 2.

Specific Resistance

After the above-mentioned aluminum-alloy foils had been immersed in liquid nitrogen, the specific resistances were measured according to the four-terminal method. The specific resistance of each sample was as shown in Table 2.

Pinholes

The external appearances of the above-mentioned aluminum-alloy foils were observed, and the presence or absence of pinholes was assessed. These results were as shown in Table 2.

Logarithmic Decrement of Damped Free Oscillations

Sheet materials were manufactured by the same method as in the above-mentioned manufacturing method of the aluminum-alloy foils except that the sheet thicknesses of the hot-rolled sheets and the cold-rolled sheets were adjusted so that the sheet thickness of the resulting strip test pieces would be 0.6 mm. Strip test pieces each having a width of 10 mm and a length of 60 mm were extracted from these sheet materials using a shaping machine. Then, the resulting strip test pieces were subjected to a heat treatment and completely recrystallized. It is noted that these strip test pieces simulate a square lithium ion secondary battery in which the number of layers of the electrodes is 40 layers.

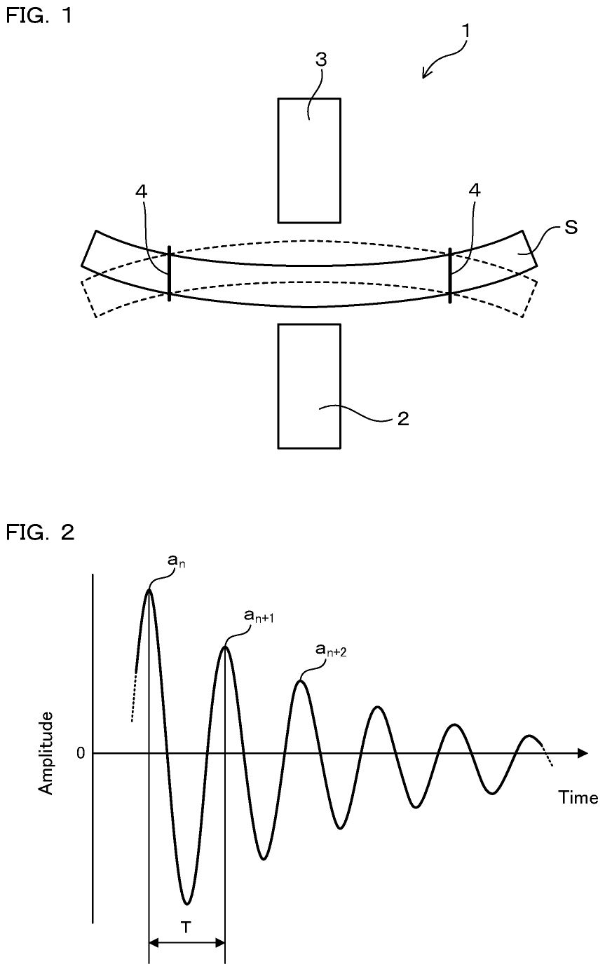

For each strip test piece prepared as described above, the logarithmic decrement of damped free oscillations was measured using a free vibration type internal friction measuring device (“JE-RT” manufactured by Nippon Techno Plus Co., Ltd.). The measurement device 1 that was used in the present example includes, as shown in FIG. 1, a drive electrode 2 and an amplitude sensor 3 that faces the drive electrode 2. A strip test piece S is horizontally placed between the drive electrode 2 and the amplitude sensor 3, and is fixed by thin wires 4 at positions that serve as oscillation nodes. In this state, the strip test piece S can be oscillated by passing an AC current through the drive electrode 2 to thereby applying a Coulomb force to the strip test piece S. Then, by measuring the amplitude of the strip test piece S using the amplitude sensor 3, a waveform of the oscillations can be obtained.

In the present example, after the strip test piece S was forcibly oscillated by passing the AC current through the drive electrode 2, the AC current was stopped, so that the strip test piece S was allowed to oscillate freely owing to the restoring force. The oscillations of the strip test piece S became so-called damped free oscillations in which the amplitude attenuates exponentially while oscillating periodically with a period T as shown in the waveform of FIG. 2. It is noted that, in a damped free oscillation, the amplitude is believed to exponentially attenuate because a loss of oscillation energy results from resistance by the atmospheric, internal friction originating at the dislocations, grain boundaries, or the like within the strip test piece, etc.

The value of the logarithmic decrement δ was calculated based on the waveform of the damped free oscillations in the following manner. First, a nth period (where n is a positive integer) and a n+mth period (where m is an integer equal to 2 or more) are arbitrarily selected from the waveform of the damped free oscillations, and the value of an amplitude aₙ of the nth period and the value of an amplitude aₙ₊ₘ of the n+mth period are obtained. Because the logarithmic decrement δ is 1n (aₖ/aₖ₊₁), which is the natural logarithm of the value of the ratio of the amplitude aₖ of the kth period to the amplitude aₖ₊₁ of the period next to the kth period, it is possible to expand 1n (aₙ/aₙ₊ₘ), which is the natural logarithm of the ratio of the amplitude aₙ to the amplitude aₙ₊ₘ, as the following equation.

1n(aₙ/aₙ₊ₘ)=1n{(aₙ/aₙ₊₁)×(aₙ₊₁/aₙ₊₂)×. . . ×(aₙ₊ₘ₋₁/aₙ₊ₘ)}=mδ

Accordingly, the value of the logarithmic decrement δ can be expressed as the following equation using the values of the amplitude aₙ of the nth period and the amplitude aₙ₊ₘ of the n+mth period.

δ=(1/m)·1n(aₙ/aₙ₊ₘ)

The logarithmic decrement of each strip test piece was as shown in Table 2.

TABLE 1

| Alloy | Chemical Composition (mass %) | | | | | | |
|---|---|---|---|---|---|---|---|
| Symbol | Fe | Si | Cu | Mn | Mg | Ti | Al |
| A | 1.35 | 0.04 | 0.025 | 0.025 | 0.012 | 0.001 | Bal. |
| B | 1.51 | 0.21 | 0.024 | 0.007 | 0.011 | 0.032 | Bal. |
| C | 1.15 | 0.05 | 0.022 | 0.015 | 0.011 | 0.012 | Bal. |
| D | 1.65 | 0.13 | 0.009 | 0.018 | 0.008 | 0.011 | Bal. |
| E | 1.45 | 0.09 | 0.011 | 0.031 | 0.015 | 0.022 | Bal. |
| F | 0.95 | 0.03 | 0.022 | 0.023 | 0.013 | 0.032 | Bal. |
| G | 1.22 | 0.04 | 0.023 | 0.012 | 0.065 | 0.032 | Bal. |
| H | 1.92 | 0.04 | 0.027 | 0.025 | 0.021 | 0.057 | Bal. |
| I | 1.18 | 0.05 | 0.022 | 0.042 | 0.037 | 0.012 | Bal. |
| J | 1.55 | 0.55 | 0.024 | 0.007 | 0.011 | 0.032 | Bal. |
| K | 1.35 | 0.02 | 0.045 | 0.025 | 0.048 | 0.170 | Bal. |
| L | 0.06 | 0.31 | 0.020 | 0.010 | 0.014 | 0.031 | Bal. |

TABLE 2

| | | | | | | | | Elongation |
|---|---|---|---|---|---|---|---|---|
| | | Specific | | Tensile Strength (MPa) | | | | After 170° C. |
| Alloy | | Resistance | Logarithmic | Initial | After 100° C. | After 120° C. | After 170° C. | Treatment |
| Symbol | Pinholes | (μΩcm) | Decrement | Stage | Treatment | Treatment | Treatment | (%) |
| A | Absent | 0.397 | 1.3 × 10⁻³ | 175 | 165 | 140 | 65 | 6.9 |
| B | Absent | 0.405 | 1.5 × 10⁻³ | 176 | 166 | 142 | 65 | 6.8 |
| C | Absent | 0.392 | 1.1 × 10⁻³ | 174 | 163 | 140 | 64 | 6.5 |
| D | Absent | 0.412 | 1.5 × 10⁻³ | 175 | 163 | 140 | 66 | 7.2 |
| E | Absent | 0.402 | 1.4 × 10⁻³ | 177 | 167 | 144 | 68 | 5.9 |
| F | Absent | 0.383 | 8.5 × 10⁻⁴ | 172 | 166 | 146 | 66 | 6.5 |
| G | Absent | 0.395 | 1.2 × 10⁻³ | 175 | 165 | 144 | 70 | 5.2 |
| H | Present | 0.456 | 1.5 × 10⁻³ | 174 | 163 | 141 | 66 | 6.3 |
| I | Absent | 0.392 | 1.8 × 10⁻³ | 176 | 166 | 140 | 64 | 5.2 |
| J | Absent | 0.410 | 1.1 × 10⁻³ | 175 | 169 | 145 | 69 | 2.8 |
| K | Present | 0.398 | 1.4 × 10⁻³ | 178 | 166 | 151 | 68 | 4.5 |
| L | Absent | 0.370 | 1.7 × 10⁻⁴ | 166 | 165 | 160 | 140 | 2.6 |

As shown in Table 1, alloys A to E have chemical compositions in the above-specified ranges. Therefore, as shown in Table 2, the initial-stage tensile strengths of aluminum-alloy foils composed of these alloys were 160 MPa or more, and the tensile strengths after having been immersed in an oil bath of 100° C. for one minute were 150 MPa or more. Moreover, the tensile strengths after having been immersed in an oil bath of 170° C. for one minute significantly decreased as compared to the initial-stage tensile strengths and the tensile strengths after having been immersed in an oil bath of 100° C. for one minute. From these results, it can be seen that the aluminum-alloy foils composed of alloys A to E exhibit the properties of not softening in a heat treatment at around 100° C., but softening and increasing elongation upon being subjected to a heat treatment at a temperature of 150 to 200° C.

In addition, the aluminum-alloy foils composed of alloys A to E exhibit an elongation of 5.6% or more after having been immersed in an oil bath of 170° C. for one minute. As was described above, the elongation of the aluminum-alloy foils composed of alloys A to E when completely recrystallized can be increased more, as compared with the aluminum alloy foils that were prepared with previously-existing composition ranges. Therefore, these aluminum-alloy foils make it possible to curtail deterioration when expansion and contraction are repeated as compared with the previously-existing aluminum-alloy foils to thereby improve durability with regard to charging/discharging cycles.

Furthermore, the logarithmic decrement of damped free oscillations in the strip test pieces, which were composed of alloys A to E and completely recrystallized, was 1.0×10⁻³ or more. Therefore, by using an aluminum-alloy foil composed of such alloys as the current collector of the positive electrode, oscillation of the current collector when vibrations are applied from the outside can be curtailed, and peeling of the positive electrode active material layer from the current collector can be curtailed accordingly.

On the other hand, with regard to alloy F, the Fe content was less than the above-specified range. Therefore, the logarithmic decrement of damped free oscillations in the strip test piece that was completely recrystallized was less than 1.0×10⁻³.

With regard to alloy G, the Mg content was greater than the above-specified range. Therefore, the elongation of the aluminum foil after having been immersed in an oil bath of 170° C. for one minute was smaller than those of alloys A to E.

With regard to alloy H, the Fe content was greater than the above-specified range. Therefore, pinholes were created during foil rolling.

With regard to alloy I, the contents of Mn and Mg were greater than the above-specified range. Therefore, the elongation of the aluminum foil after having been immersed in an oil bath of 170° C. for one minute was smaller than those of alloys A to E.

With regard to alloy J, the Si content was greater than the above-specified range. Therefore, the elongation of the aluminum foil after having been immersed in an oil bath of 170° C. for one minute was smaller than those of alloys A to E.

With regard to alloy K, the Ti content was large. Therefore, pinholes were created during foil rolling. In addition, the contents of Cu and Mg were greater than the above-specified range. Therefore, the elongation of the aluminum foil after having immersed in an oil bath of 170° C. for one minute was smaller than those of alloys A to E.

Alloy L is JIS A1050 alloy, which has been used in the past as an aluminum alloy foil for a current collector. The Fe content of alloy L is less than the above-specified range, and thus the logarithmic decrement of damped free oscillations in the strip test piece that was completely recrystallized was less than 1.0×10⁻³. In addition, alloy L tends not to recrystallize when subjected to a heat treatment at a temperature of 150 to 200° C., and therefore the elongation of the aluminum foil after having been immersed in an oil bath of 170° C. for one minute was smaller than those of alloys A to E.

1. An aluminum-alloy foil for a current collector having:
a chemical composition containing Fe: 1.1-1.8 mass %, Si: 0.30 mass % or less, Cu: 0.030 mass % or less, Mg: 0.030 mass % or less, Mn: 0.040 mass % or less, and Ti: 0.030 mass % or less, the remainder being Al and unavoidable impurities; and
a cold-worked structure,
wherein the aluminum-alloy foil has a recrystallization start temperature of 150° C. or higher, and
when the aluminum-alloy foil is in a state of being completely recrystallized, the aluminum-alloy foil exhibits properties of an elongation of 5.6% or more and a logarithmic decrement of damped free oscillations of 1.0×10⁻³ or more.

2. The aluminum-alloy foil for a current collector according to claim 1, wherein the aluminum-alloy foil has a tensile strength of 160 MPa or more.

3. The aluminum-alloy foil for a current collector according to claim 2, wherein the tensile strength of the aluminum-alloy foil after having been immersed in an oil bath of 100° C. for one minute is 150 MPa or more.

4. The aluminum-alloy foil for a current collector according to claim 1, wherein Al-Fe-based compounds having a circle-equivalent diameter of 10-50 nm are dispersed in the Al matrix of the aluminum-alloy foil at 800 particles/μm³ or more.

5. The aluminum-alloy foil for a current collector according to claim 4, wherein an amount of solid-solution Fe in the Al matrix is 0.015 to 0.035 mass %.

6. The aluminum-alloy foil for a current collector according to claim 1, wherein when the aluminum-alloy foil is in a state of being completely recrystallized, the aluminum-alloy foil for a current collector exhibits the property that an amount of solid-solution Fe in the Al matrix falls within 0.010 to 0.030 mass %.

7. A method of manufacturing the aluminum-alloy foil for a current collector according to claim 1, comprising:
preparing an ingot having said chemical composition;
performing a homogenizing treatment by holding the ingot at a temperature of 400-580° C.;
preparing a hot-rolled sheet by performing hot-rolling on the ingot under the condition that the coiling temperature is the recrystallization temperature of said chemical composition or less;
preparing a cold-rolled sheet by performing cold-rolling on the hot-rolled sheet;
performing an intermediate annealing by holding the cold-rolled sheet at a temperature of 300-340° C.; and
performing foil rolling on the cold-rolled sheet under the condition that the rolling ratio is set to 85% or more, and the coiling temperature is less than 90° C.

8. The method according to claim 7, wherein the recrystallization temperature is a temperature at which the Al matrix of the hot-rolled sheet completely recrystallizes when the hot-rolled sheet is held at said temperature for one hour.

9. The method according to claim 7, wherein the coiling temperature is 260° C. or less.

10. The method according to claim 7, further comprising subjecting the hot-rolled sheet to an annealing treatment at a temperature of 320-400° C. for 1-10 hours prior to preparing the cold-rolled sheet.

11. The method according to claim 7, wherein the rolling ratio in the foil rolling is 95% or more.

12. The method according to claim 7, wherein the foil rolling is performed in a plurality of passes and the coiling temperature of the aluminum-alloy foil after each of the passes is less than 90° C.

13. The method according to claim 7, further comprising:
subjecting the hot-rolled sheet to an annealing treatment at a temperature of 320-400° C. for 1-10 hours prior to preparing the cold-rolled sheet;
wherein:
the coiling temperature in the hot rolling step is 260° C. or less;
the rolling ratio in the foil rolling step is 95% or more; and
the foil rolling is performed in a plurality of passes and the coiling temperature of the aluminum-alloy foil after each of the passes is less than 90° C.

14. The method according to claim 7, further comprising:
after the foil rolling step, heating the aluminum-alloy foil at a temperature of 150° C. or higher until the aluminum-alloy foil is completely recrystallized.

15. The aluminum-alloy foil according to claim 1, wherein the aluminum-alloy foil is completely recrystallized and has an Al matrix that contains 0.010 to 0.030 mass % of solid-solution Fe.

16. The aluminum-alloy foil according to claim 15, wherein Al-Fe-based compounds having a circle-equivalent diameter of 10-50 nm are dispersed in the Al matrix at 800 particles/μm³ or more.

17. The aluminum-alloy foil according to claim 1, wherein:
the aluminum-alloy foil contains 1.1-1.6 mass % Fe, and 0.020 mass % or less of Zn, Ga, Ni, Cr, Sn, Pb, and V; and
the recrystallization start temperature of the aluminum-alloy foil is 200° C. or less.

18. The aluminum-alloy foil according to claim 1, wherein the aluminum-alloy foil is prepared by a process comprising:
preparing an ingot having said chemical composition;
performing a homogenizing treatment by holding the ingot at a temperature of 400-580° C.;
preparing a hot-rolled sheet by performing hot-rolling on the ingot under the condition that the coiling temperature is the recrystallization temperature of said chemical composition or less;
preparing a cold-rolled sheet by performing cold-rolling on the hot-rolled sheet;
performing an intermediate annealing by holding the cold-rolled sheet at a temperature of 300-340° C.; and
performing foil rolling on the cold-rolled sheet under the condition that the rolling ratio is set to 85% or more, and the coiling temperature is less than 90° C.

19. An aluminum-alloy foil prepared by a process comprising:
preparing an ingot of an aluminum alloy comprising Fe: 1.1-1.8 mass %, Si: 0.30 mass % or less, Cu: 0.030 mass % or less, Mg: 0.030 mass % or less, Mn: 0.040 mass % or less, and Ti: 0.050 mass % or less;
homogenizing the ingot at a temperature of 400-580° C.;
hot-rolling the ingot to form a hot-rolled sheet such that the hot-rolled sheet is held at a coiling temperature that is not higher than the recrystallization temperature of the aluminum alloy;
allowing the hot rolled sheet to cool, thereby providing a cooled sheet;
cold-rolling the cooled sheet to reduce the thickness of the cooled sheet, thereby providing a cold-rolled sheet;
annealing the cold-rolled sheet at a temperature of 300-340° C.; and
thereafter, foil rolling the cold-rolled sheet to reduce the thickness of the cold-rolled sheet by 85% or more, thereby forming the aluminum-alloy foil;
wherein during the foil rolling, the cold-rolled sheet is held at a coiling temperature of less than 90° C.

20. The aluminum-alloy foil according to claim 19, wherein the process further comprises:
recrystallizing the aluminum-alloy foil at a temperature of 150° C. or higher until the aluminum-alloy foil is completely recrystallized and the aluminum-alloy foil exhibits an elongation of 5.6% or more and a logarithmic decrement of damped free oscillations of 1.0×10⁻³ or more.

21. The aluminum-alloy foil according to claim 1, wherein the aluminum-alloy foil has a tensile strength of 150 MPa or more after having been immersed in an oil bath of 100° C.
